(19) United States
(12) Patent Application Publication
(10) Pub. No.: US 2016/0040699 A1
(43) Pub. Date: Feb. 11, 2016

(54) ADJUSTABLE COUPLING AND SYSTEM FOR SOLAR PANEL SUPPORT

(71) Applicant: Polar Racking, Inc., Windsor (CA)

(72) Inventor: Manish Nayar, Windsor (CA)

(73) Assignee: Polar Racking, Inc., Windsor (CA)

(21) Appl. No.: 14/699,490

(22) Filed: Apr. 29, 2015

Related U.S. Application Data
(60) Provisional application No. 62/035,699, filed on Aug. 11, 2014.

(51) Int. Cl. F16B 5/02

(52) U.S. Cl. CPC F16B 5/0225

(57) ABSTRACT

A coupling for mounting a structure to an object is provided. The coupling includes a pair of flanges releasably attachable to one another with planar surfaces thereof disposable in abutting relation. A plurality of linear slots is defined through one of the pair of flanges, and a plurality of arcuate slots is defined through the other of the pair of flanges. The linear and arcuate slots are arranged, shaped and dimensioned such that the flanges are alignable to overlap the linear and arcuate slots to define a plurality of through-bores for receiving fasteners, and such that they define a range of translational motion within which the flanges can be translated relative to one another and a range of rotational motion within which the flanges can be rotated relative to one another. At least one of the plurality of through-bores is maintained throughout the translational and rotational ranges.

### STATEMENT OF RELATED APPLICATIONS

This application claims the benefit of U.S. Provisional Patent Application No. 62/035,699 having a filing date of 11 Aug. 2014.

### BACKGROUND OF THE INVENTION

1. Technical Field

The present invention relates to an adjustable coupling and system for supporting solar panels or other structures.

2. Prior Art

Solar panels are often ground-mounted. This is typically achieved using posts that are disposed beneath the panel and securely affixed to the ground by cementing an end of the post into the ground. The post is typically connected to an underside of the panel by a bolted connection. One commonly utilized post is comprised of a ground segment affixed to the ground at a ground-contacting end, and an upper segment for attachment to the panel at a panel-contacting end. The ground segment and the upper segment each terminate in a ground segment flange and an upper segment flange, respectively. The flanges are releasably attachable to one another via planar surfaces in a flange-to-flange connection, forming a coupling. The releasable attachment of the flanges may be achieved through the use of nuts and bolts, the latter being passed through-bores in the flanges and therefore requiring relatively precise alignment of the bores in order to attach the flanges to one another. Alignment amongst the ground segment flange bores and the upper segment flange bores can be difficult to achieve, particularly in an installation that utilizes multiple posts to support a given panel.

### BRIEF SUMMARY OF THE INVENTION

There is provided a coupling for mounting a structure to an object, the coupling comprising a pair of flanges that are releasably attachable to one another with planar surfaces thereof disposable in an abutting relation, a plurality of linear slots defined through one of said pair of flanges, and a plurality of arcuate slots defined through the other of said pair of flanges, said linear and arcuate slots being arranged, shaped and dimensioned such that the flanges are alignable to overlap said linear and arcuate slots to define a plurality of through-bores for receiving fasteners, and such that they define a range of translational motion within which the flanges can be translated relative to one another and a range of rotational motion within which the flanges can be rotated relative to one another, at least one of said plurality of through-bores being maintained throughout said translational and rotational ranges.

There is also provided a system for supporting a structure above a ground or surface, the system comprising a plurality of posts, each post including a ground segment for attaching to the ground or surface, and an upper segment for attaching to the structure, the ground segment including a ground segment flange and the upper segment including an upper segment flange, the ground segment flange and the upper segment flange being releasably attachable to one another along respective planar surfaces, wherein one of the ground segment flange and the upper segment flange has a plurality of linear slots and the other of the ground segment flange and the upper segment flange has a plurality of arcuate slots, said linear and arcuate slots being arranged, shaped and dimensioned such that the flanges are alignable to overlap said linear and arcuate slots to define a plurality of through-bores for receiving fasteners, and such that they define a range of translational motion within which the flanges can be translated relative to one another and a range of rotational motion within which the flanges can be rotated relative to one another, at least one of said plurality of through-bores being maintained throughout said translational and rotational ranges.

There is further provided a coupling for aligning an area of attachment of a structure with an area of attachment on a ground or surface, the coupling comprising an upper flange attachable to the area of attachment of the structure and a lower flange attachable to the area of attachment on the ground or surface, the upper and lower flanges being releasably securable to one another with planar surfaces thereof disposed in an abutting relation, a plurality of linear slots defined through one of the upper and lower flanges, and a plurality of arcuate slots defined through the other of the upper and lower flanges, said linear and arcuate slots being arranged, shaped and dimensioned such that the flanges are alignable to overlap said linear and arcuate slots to define a plurality of through-bores for receiving fasteners, and such that they define a range of translational motion within which the flanges can be translated relative to one another and a range of rotational motion within which the flanges can be rotated relative to one another, at least one of said plurality of through-bores being maintained throughout said translational and rotational ranges.

Further aspects of the invention will become apparent from the following description taken together with the accompanying drawings.

### BRIEF DESCRIPTION OF THE DRAWINGS

For a better understanding of the present invention, and to show more clearly how it may be carried into effect, reference will now be made, by way of example, to the accompanying drawings which show exemplary embodiments of the present invention in which:

FIG. 1 is an upper perspective view of an adjustable coupling constructed in accordance with an embodiment of the present invention;

FIG. 2 is a bottom view of the coupling shown in FIG. 1, without fasteners therein;

FIG. 3 is an upper perspective view of a flange on a ground segment of a panel support post;

FIG. 4 is a transparent upper perspective view of the coupling shown in FIG. 1;

FIG. 5 is a partially transparent lower perspective view of the coupling shown in FIG. 1;

FIG. 6 is an upper perspective view of the coupling shown in FIG. 1 with the two flanges rotationally displaced relative to one another;

FIG. 7 is an upper perspective view of the coupling shown in FIG. 1 with the two flanges translationally displaced relative to one another;

FIG. 8 is a perspective view of the coupling shown in FIG. 7;

FIG. 9 is an upper perspective view of the coupling shown in FIG. 1 with the two flanges rotationally and translationally displaced relative to one another;

FIG. 10 is a perspective view of an adjustable coupling constructed in accordance with a further embodiment of the invention;

FIG. 11 is a perspective view of a system for supporting a solar panel, constructed in accordance with an embodiment of the present invention;

FIG. 12 is a plan view of the upper flange of the coupling of FIG. 1;

FIG. 13 is a plan view of the coupling of FIG. 12 wherein the upper and/or lower flange has been translated; and

FIG. 14 is a plan view of the coupling of FIG. 13 wherein the upper and/or lower flange has been rotated.

### DETAILED DESCRIPTION OF PREFERRED EMBODIMENTS

The present invention may be embodied in a number of different forms. The specification and drawings that follow describe and disclose some of the specific forms of the invention.

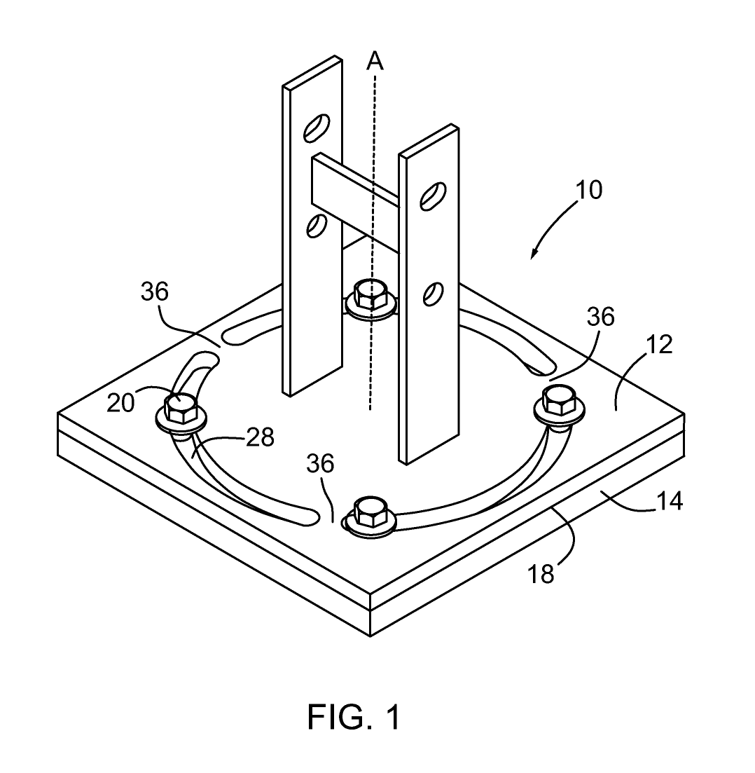

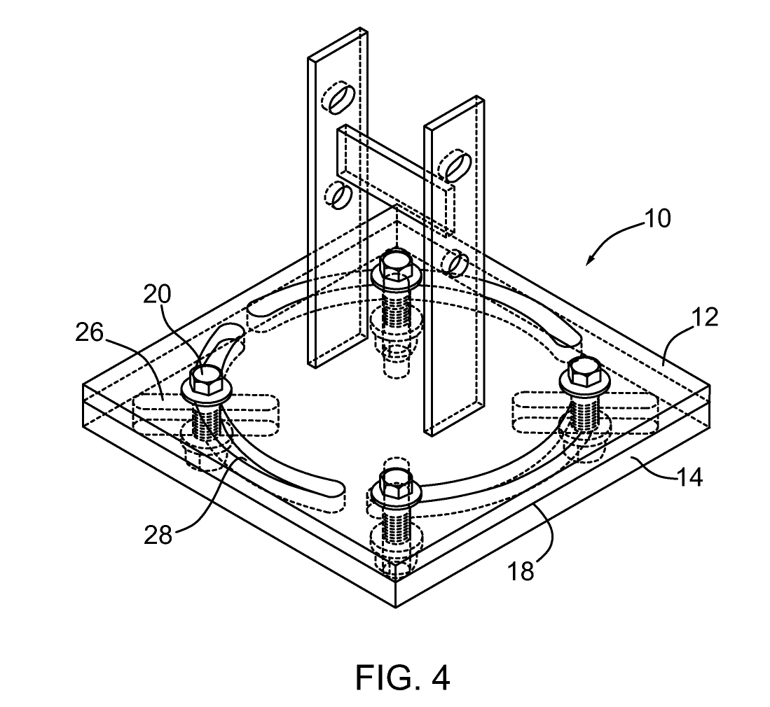

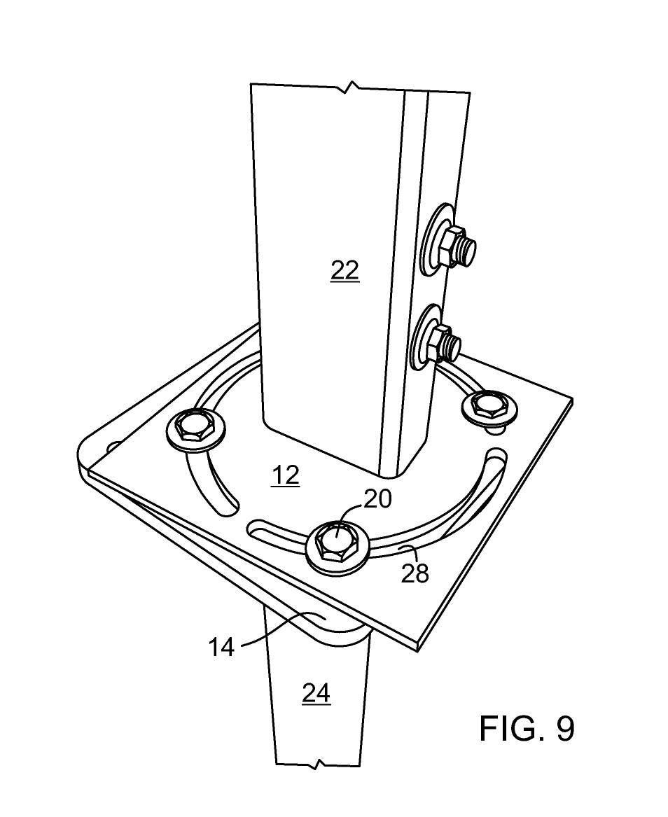

Referring to FIGS. 1 through 9, a coupling for use in the mounting of a solar panel or structure to an object, constructed in accordance with an embodiment of the invention, is noted generally by reference numeral 10. The coupling includes a pair of flanges 12 and 14, each having a generally planar surface 16.

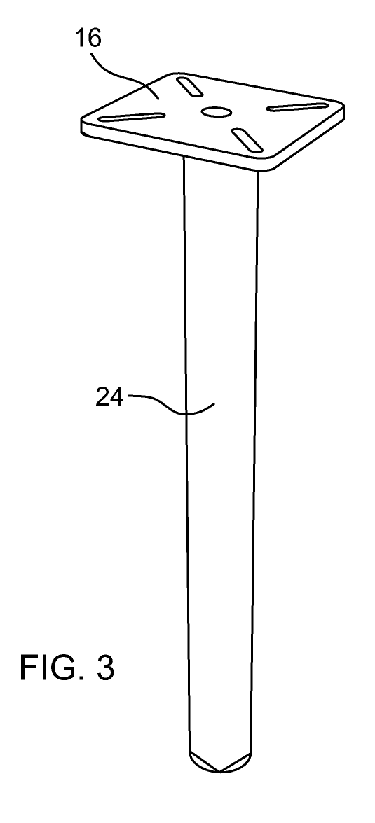

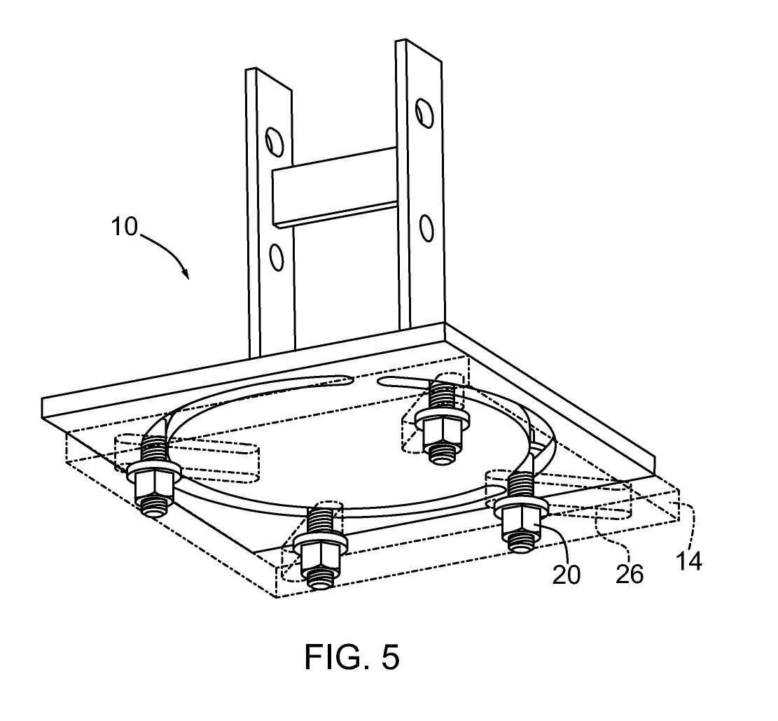

As shown in FIG. 1, flanges 12 and 14 can be releasably attached to one another such that planar surfaces 16 (see FIGS. 3 and 5) abut to define an abutting plane 18. Fasteners 20 (which may be nuts and bolts, or any one of a variety of other fasteners) releasably attach the flanges to one another. When the fasteners are sufficiently tightened, clamped, or otherwise forced against the flanges they help to prevent relative motion between the flanges. Flanges 12 and 14 may be affixed to respective upper and lower post segments 22 and 24, as is best shown in FIGS. 3, 9 and 10.

In one embodiment, coupling 10 includes a plurality of linear slots 26 extending through one of flanges 12 and 14, and a plurality of arcuate slots 28 extending through the other of flanges 12 and 14. In the embodiment of FIGS. 1 through 9, upper flange 12 includes arcuate slots 28 and lower flange 14 includes linear slots 26. Arcuate slots 28 are arranged on flange 12 such that they are segments of a common circle and spaced apart by a common distance.

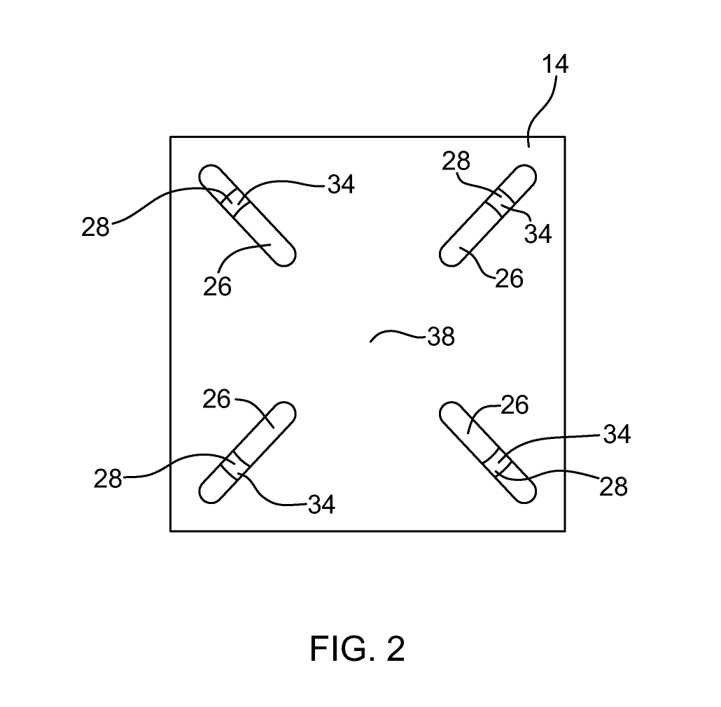

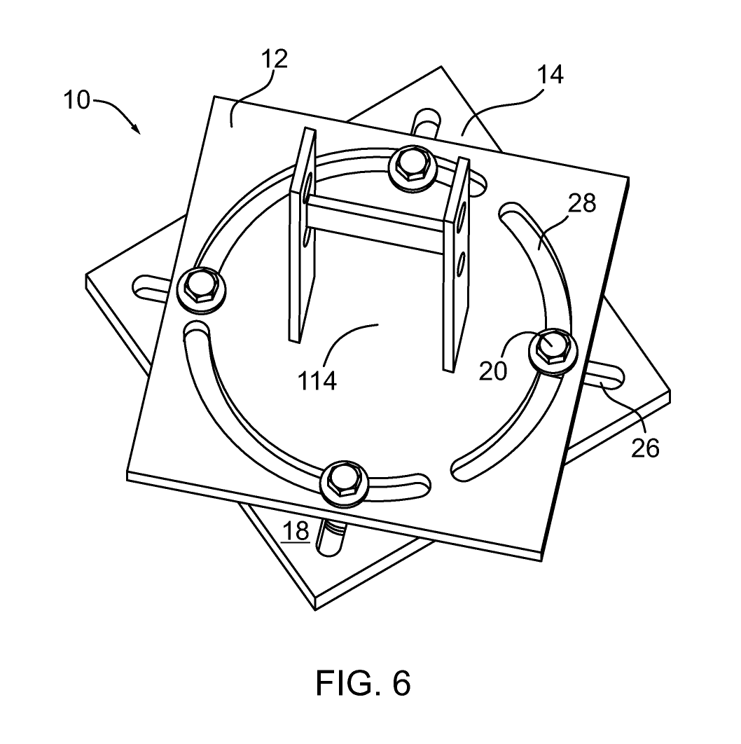

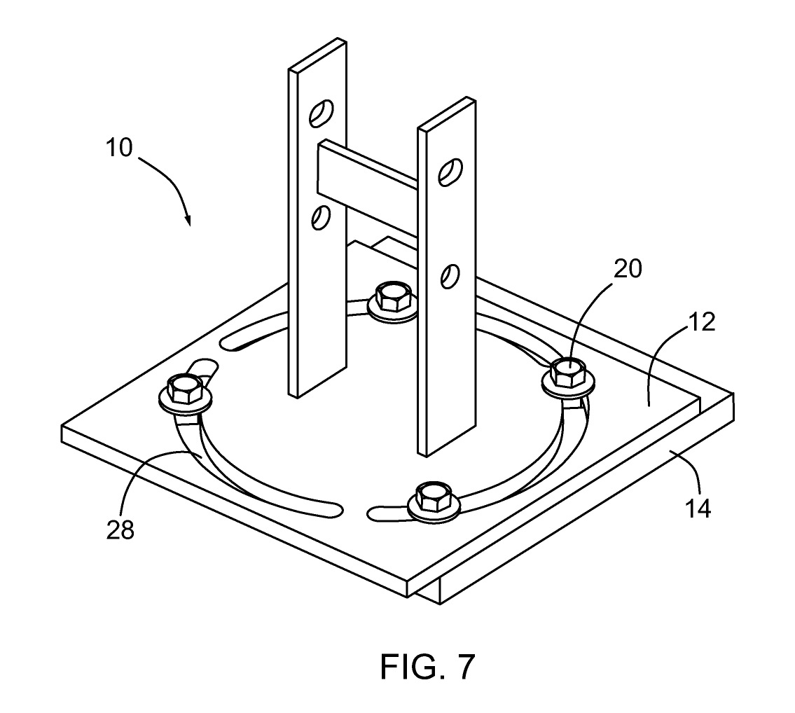

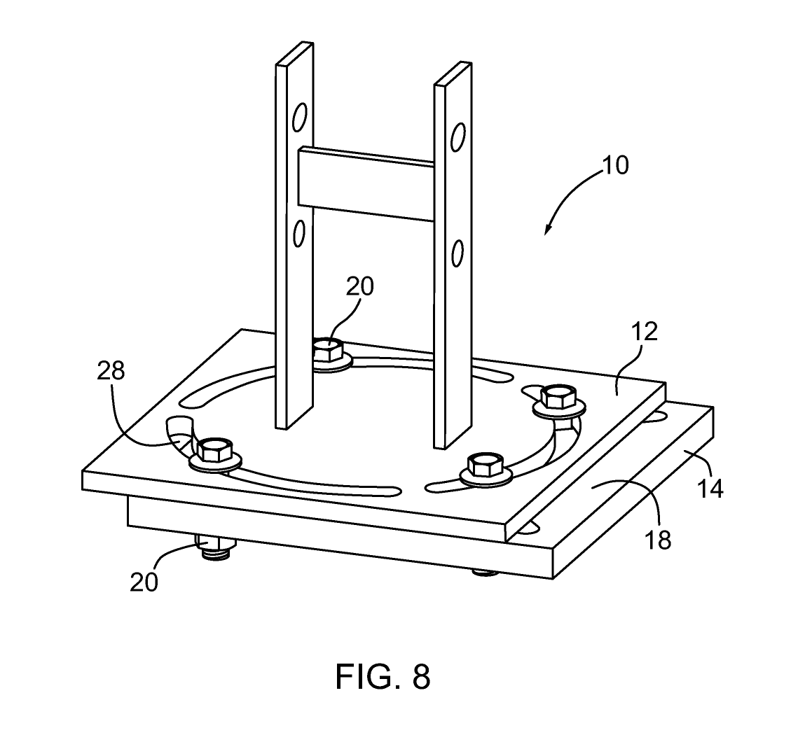

When flanges 12 and 14 are releasably attached to one another, linear slots 26 and arcuate slots 28 overlap to define one or more through-bores or overlapping areas 34 for receiving fasteners 20, as best shown in FIG. 2. As discussed in greater detail below, linear slots 26 are arranged, shaped and dimensioned to define a range of translational motion within which flanges 12 and 14 can be translated relative to one another while maintaining one or more through-bores 34. Such relative translational displacement is shown, for example, in FIGS. 7 and 8. Similarly, arcuate slots 28 are arranged, shaped and dimensioned to define a range of rotational motion within which flanges 12 and 14 can be pivoted relative to one another while maintaining one or more through-bores 34. Such relative rotational displacement is shown, for example, in FIG. 6. The translational and rotational ranges are those ranges of movement through which flange 12 and/or flange 14 can be moved, when they are adjacent one another such that their slots overlap to define through-bore(s) 34, while maintaining at least one through-bore 34. It will be appreciated that the fewer the number of through-bores 34 that are to be maintained, the greater the freedom of relative rotational and/or translational motion of flanges 12 and 14 relative to one another. It will further be appreciated that the greater the length of the linear and arcuate slots, the greater the translational and/or rotational ranges will be. Furthermore, movement of the flanges relative to one another through the translational and/or rotational ranges may occur before fasteners 20 are utilized to secure the flanges together, or after fasteners 20 are received within the through-bore(s). Where fasteners 20 are received within the through-bore(s) prior to the positioning of the flanges, the fasteners would not be tightened or configured to restrict the movement of the flanges so as to permit the relative movement of the flanges through the translational and/or rotational ranges. Once the flanges are in the desired arrangement, they may be secured together by fasteners 20.

Arcuate slots 28 may terminate in close proximity to one another (as shown in FIGS. 1 and 4 to 9) so as to maximize the rotational range. Arcuate slots 28 are separated by bridging portions 36. In general, the greater the number of bridging portions, the greater the structural integrity of the flange, but the lesser the freedom of relative rotational movement afforded by slots 28, as each slot will be correspondingly shorter in length. A flange having two arcuate slots that terminate in close proximity to each other, thereby forming between them two bridging portions, would yield a high degree of rotational movement. A flange having three arcuate slots terminating in close proximity to one another, as shown in the attached figures, would yield a range of rotational movement that affords a degree of relative rotational motion between the flanges which is less than that of a flange having two proximate arcuate slots. However, a flange with three slots may in some cases present a higher degree of integral strength.

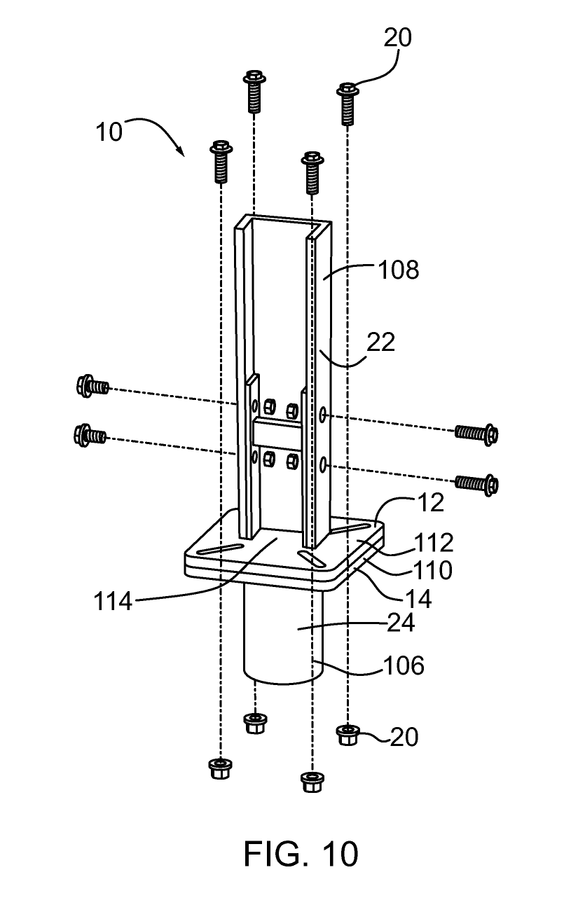

In the embodiments shown, bottom flange 14 contains four linear slots 26 that extend outwardly, from a central portion 38 of the flange, in a generally radial manner. Although the embodiment shown in the attached drawings depicts an upper flange with three arcuate slots and a lower flange with four linear slots, it will be appreciated that other numbers and combinations of slots could be utilized. It will also be appreciated that arcuate slots 28 could be located in lower flange 14 and linear slots 26 could be located in upper flange 12, as shown in FIG. 10.

The four linear slots 26, shown in the attached figures, are typically disposed in a cruciform relationship to one another, extending radially from central portion 38. When flanges 12 and 14 are releasably attached to one another, there will thus be four through-bores or overlapping areas 34 defined in the coupling, as best shown in FIG. 2. Further, as also shown in FIG. 2, when flanges 12 and 14 are aligned, each linear slot 26 of flange 14 is substantially bisected by one of arcuate slots 28 of flange 12.

It will be appreciated that linear slots 26 could be made shorter, thereby lessening the relative translational movement of the flanges in use. Alternately, slots 26 could be made longer, thereby increasing the possible translational movement. Further, linear slots 26 may be formed within the flange such that they are arranged and dimensioned to permit the attachment of post 22 or 24 to the flange.

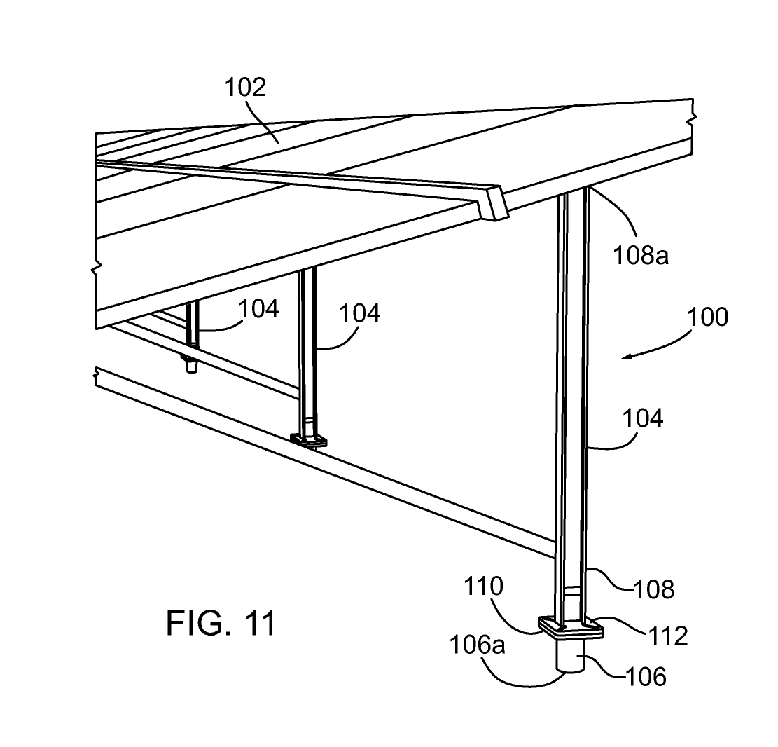

Referring to FIG. 11, in accordance with another embodiment, there is provided a system 100 for supporting a solar panel 102 above the ground or a surface. System 100 includes a plurality of posts 104. Referring to FIGS. 10 and 11, each post includes a ground segment 106 for attaching to the ground at a ground contacting end 106a thereof, and an upper segment 108 for attaching to solar panel 102 at a contacting end 108a thereof. Ground segment 106 terminates in a ground segment flange 110 which is disposed opposite ground-contacting end 106a. Similarly, upper segment 108 terminates in an upper segment flange 112 which is located opposite contacting end 108a of upper segment 108. Upper segment flange 112 and ground segment flange 110 are similar to flanges 12 and 14 described above, containing arcuate and linear slots. In this embodiment, flanges 12 and 14 may be constructed such that the slots therein provide sufficient clearance about their centers 114 for post segments 106, 108 to be attached thereto, as shown in FIGS. 1 to 10. It will be appreciated that the posts may be attached to their respective flanges other than at the centers of the flanges, and in those cases the clearance provided by the slots for the posts may not be about the flange centers.

Each of ground segment flange 110 and upper segment flange 112 has planar surface 16 similar to that shown, for example, in FIGS. 3 and 5 for the embodiment shown in FIGS. 1 through 9. In use, flanges 110 and 112 are releasably attached to one another via fasteners 20, with planar surfaces 16 thereof disposed in abutting relation to define a two-dimensional abutting plane 18. As described, one of the flanges has a plurality of radially extending linear slots 26, while the other has a plurality of arcuate slots 28. As such, flanges 110 and 112 can be translated and/or rotated relative to one another in generally the same manner described for the embodiment shown in FIGS. 1 through 9.

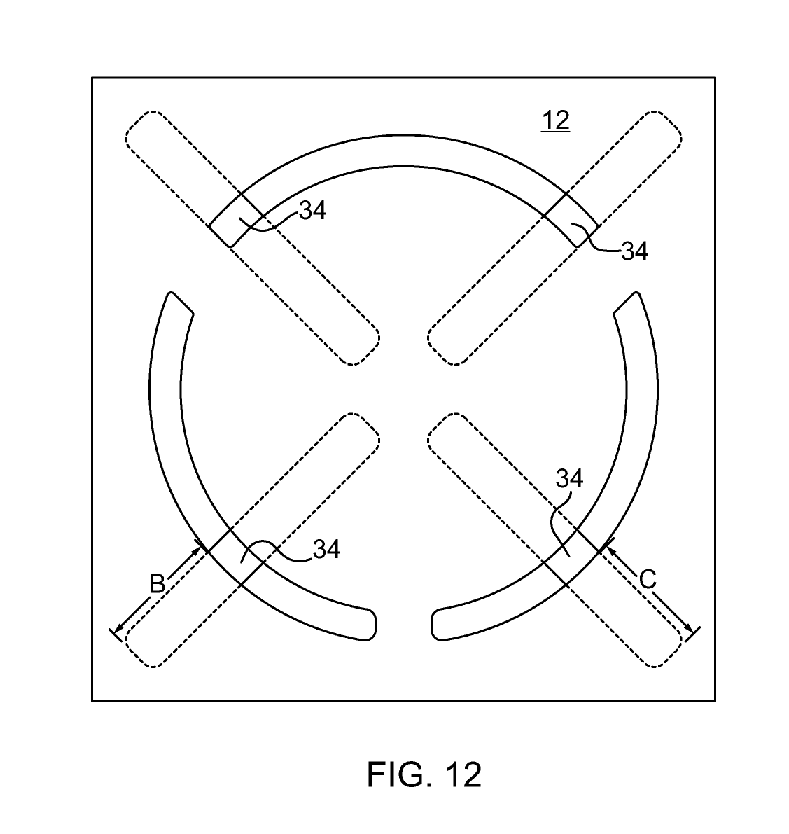

In use, coupling 10 and/or system 100 may be used to facilitate the supporting, anchoring, or attachment of a solar panel to a surface to which one of flanges 12 or 14 or flanges 110 or 112 are attached, typically through the use of ground segments 106. Attachment to the surface may be through cementing, screwing, or some other manner. As best shown in FIGS. 12 to 14, the translational and/or rotational movement afforded by the coupling, when the flanges are releasably attached to one another, allows users to translate and/or rotate the flanges relative to one another in order to assist in aligning and positioning upper post segment 22 or 108 (as the case may be). Flanges 12 and 14, shown in FIGS. 12 through 14, are as previously described for the embodiment shown in FIGS. 1 through 9.

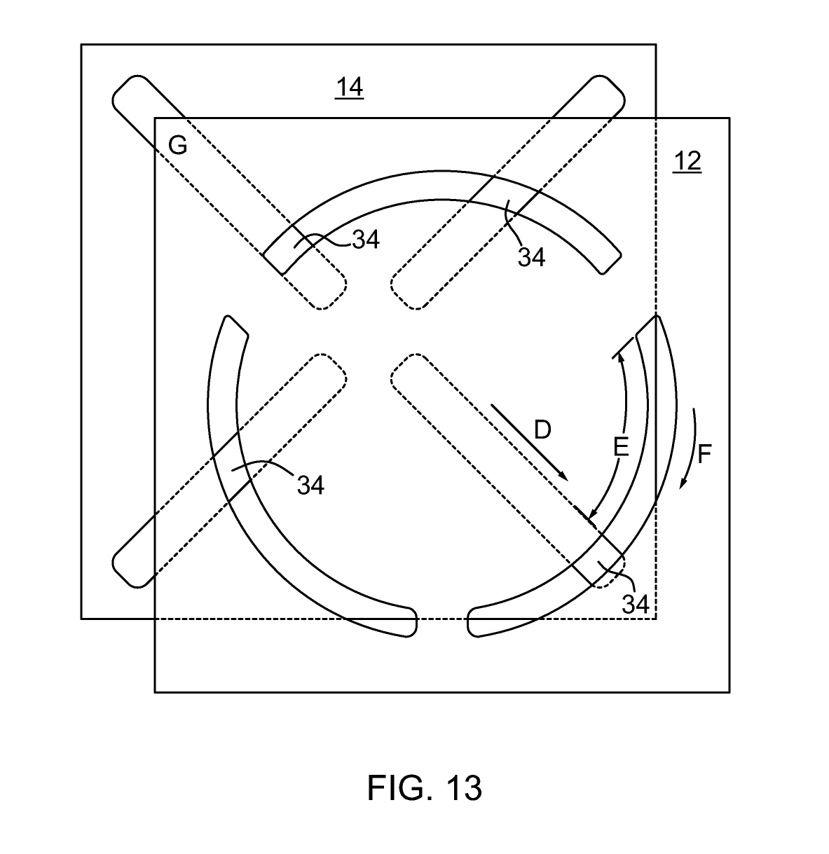

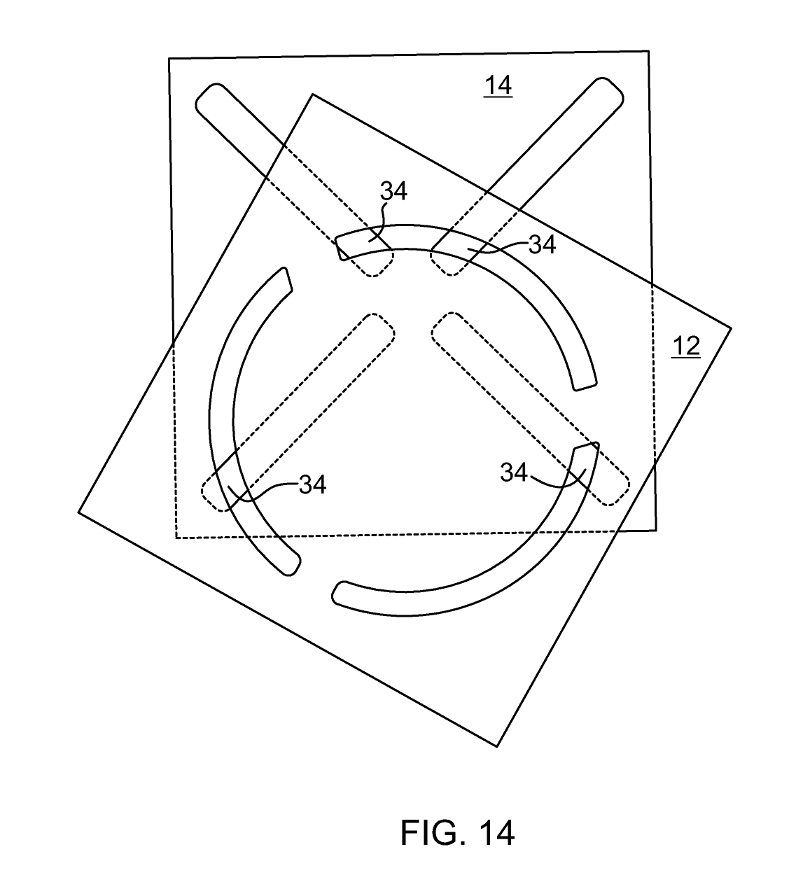

FIG. 12 demonstrates flanges 12 and 14 overlapped such that they are substantially aligned, with flange 12 translatable through approximate distances “B”, “C” or “H”, for example, while maintaining all four through-bores 34. FIG. 13 shows the relative arrangement of the flanges after one possible translational movement, that is, once flange 12 has been translated through distance “C”, in a direction “D”. The four through-bores 34 are maintained throughout the entirety of the translational movement. Once flanges 12 and 14 are in the arrangement shown in FIG. 13, one possible rotational range available to flange 12 is shown by distance “E”. Once flange 12 is rotated around a pivot point “G”, through distance “E” in a direction “F”, the configuration shown in FIG. 14 results. The four through-bores 34 are also maintained throughout the entirety of the rotational movement.

It will be appreciated that the relative movements shown in FIGS. 12 to 14 represent only one possible combination of movements. The person of skill in the art will understand that other ranges of movement, translationally and/or rotationally, are possible. Further, the person of skill will understand that other slot configurations (e.g., different numbers, lengths and/or arrangements of linear and/or arcuate slots) would provide different translational and/or rotational ranges of movement. Further, it will be appreciated that while movement through one possible translational range and one possible rotational range is depicted in FIGS. 12 to 14 in sequence, a user of coupling 10 or system 100 will be able to simultaneously move flanges 12 and/or 14 through both ranges. Generally, a user will be able to translate, translate and then rotate, rotate, rotate and then translate, or simultaneously rotate and translate flanges 12 and/or 14 relative to one another.

Coupling 10 and/or system 100 is therefore expected to facilitate alignment of multiple lower flanges attached to a surface, such as the ground, with respective upper flanges attached to, or for attachment to, a solar panel having fixed areas of attachment for the upper flanges, through increased rotational and/or translational freedom.

One of ordinary skill in the art will appreciate that in alternate embodiments of the invention, the particular nature, positioning and dimensions of arcuate slots 28 and linear slots 26 could be other than that shown in the attached drawings. In accordance with another embodiment, arcuate slots 28 have a common axis about which they are circumscribed (e.g., axis “A”, shown in FIG. 1), and one or more of the arcuate slots are disposed at a radius or radii that is, or are, different from the radius or radii of one or more of the other arcuate slots. In yet a further embodiment, one or more of arcuate slots 28 may be circumscribed about an axis that is different from that of the other arcuate slots. A further embodiment combines the two previously described embodiments, so that one or more of arcuate slots 28 has a different axis about which it is circumscribed than that of the other arcuate slots, and one or more of the arcuate slots are disposed at a radius or radii that is, or are, different from the radius or radii of one or more of the other arcuate slots. In yet a further embodiment, which is applicable to any of the previously described embodiments, arcuate slots 28 and/or linear slots 26 may have varying or different lengths.

While the combination of arcuate and linear slots shown in the attached drawings is expected to provide an increased degree of rotational and/or translational movement over currently used structures, varying slot lengths, radii, axes, slot arrangements, the number of slots, etc., will yield other ranges of rotational and/or translational movement. Alternate embodiments may also present more or fewer through-bores than the four shown in the accompanying figures.

It will further be appreciated that while slots 26 have been described as “linear”, slots 26 need not be perfectly straight. The linear slots may be slightly curved, undulating, or somewhat irregular, provided that they present a different, generally linear pathway compared to the rotational path provided by arcuate slots 28. It is expected that the combination of varying translational and rotational movement created by the overlapping of differently arranged slots will yield increased rotational and/or translational freedom in the relative movement between the flanges.

While releasable attachment of the parts or flanges has been described through the use of a fastener through each of the through-bores 34, releasable attachment may alternately be achieved using one or more fasteners through one or more of the through-bores. Further, if desired, enhanced flexibility may be imparted to a user of the system by translating and/or rotating the flanges relative to each other without fasteners 20 received in the through-bores, so that optimal positioning can be achieved without restriction on the degree of rotational and/or translational movement that might otherwise have been caused by receipt of fasteners within one or more of the through-bores. In that scenario, once the user has oriented the parts or flanges as desired, fasteners can be placed within the through-bores that are formed by the relative arrangement of the flanges. The number of through-bores formed by any such arrangement may be less than that which is formed when the flanges are substantially aligned along their edges, as in FIG. 12. Further, depending on the dimensions of the slots, multiple fasteners may be received within a single through-bore. Accommodating the receipt of fasteners after the flanges have been positioned may require the use of alternate forms of fasteners, including lugs, screws, etc. Alternately, sufficient room will need to be left below bottom flange 14 to permit the insertion of a bolt or nut.

In prior art structures, where multiple posts are used to support one or more solar panels, the lower flanges are commonly fixed to the ground, at certain areas of attachment, in an arrangement that is expected to align with corresponding areas of attachment on the solar panels. Upper flanges are attached to the areas of attachment on the solar panels, typically by upper post segments, and must be precisely aligned with the lower flanges (which are typically attached to the ground through the use of ground post segments) such that their bores align to permit the attachment of the flanges to one another. This procedure is often subject to inaccuracies in the placement of the ground posts, which results in misalignment of the flanges and a difficulty or inability to secure the flanges together. Coupling 10 and/or system 100 may be used to facilitate the alignment procedure. The translational and rotational ranges of movement provided by arcuate slots 28 and linear slots 26 is expected to provide an increased degree of relative movement between the flanges over currently used structures. The positioning of upper flange 12 relative to lower flange 14 can be “fine-tuned” for each area of attachment on the solar panel, such that the upper flange aligns with its respective lower flange (which is fixedly secured in place to the ground) in a manner that provides at least one through-bore 34 for securing the flanges to each other using fastener(s) 20.

While coupling 10 and/or system 100 will typically be used to support solar panels above a ground surface, it will be appreciated that coupling 10 and/or system 100 may also be used to attach such panels to a wall or an elevated surface, such as a roof, etc. Further, coupling 10 and/or system 100 may be used to support other structures and not just solar panels.

It is to be understood that what has been described are exemplary embodiments of the invention. The scope of the claims should not be limited by the embodiments set forth above, but should be given the broadest interpretation consistent with the description as a whole.

What is claimed is:

1. A coupling for mounting a structure to an object, the coupling comprising:
a pair of flanges that are releasably attachable to one another with planar surfaces thereof disposable in an abutting relation,
a plurality of linear slots defined through one of said pair of flanges, and
a plurality of arcuate slots defined through the other of said pair of flanges,
said linear and arcuate slots being arranged, shaped and dimensioned such that the flanges are alignable to overlap said linear and arcuate slots to define a plurality of through-bores for receiving fasteners, and such that they define a range of translational motion within which the flanges can be translated relative to one another and a range of rotational motion within which the flanges can be rotated relative to one another, at least one of said plurality of through-bores being maintained throughout said translational and rotational ranges.

2. The coupling of claim 1, wherein one of said pair of flanges is operatively associated with the structure in use and the other of said pair of flanges is operatively associated with the object in use.

3. The coupling of claim 1, wherein said arcuate slots are segments of a common circle and spaced apart by a common distance.

4. The coupling of claim 1, wherein said linear slots extend outwardly in a generally radial manner from a central portion of the one of the pair of flanges.

5. The coupling of claim 1, wherein said plurality of linear slots are four in number and extend outwardly in a generally radial manner from a central portion of the one of the pair of flanges, and said plurality of arcuate slots are three in number and are segments of a common circle and spaced apart by a common distance.

6. The coupling of claim 5, wherein said linear slots are disposed in a cruciform relationship.

7. The coupling of claim 6, wherein said plurality of through-bores is four in number.

8. The coupling of claim 7, wherein said linear slots and said arcuate slots are shaped and dimensioned such that when the flanges are aligned, each said linear slot is substantially bisected by one of said arcuate slots.

9. A system for supporting a structure above a ground or surface, the system comprising:
a plurality of posts, each post including
a ground segment for attaching to the ground or surface, and
an upper segment for attaching to the structure,
the ground segment including a ground segment flange and the upper segment including an upper segment flange, the ground segment flange and the upper segment flange being releasably attachable to one another along respective planar surfaces,
wherein one of the ground segment flange and the upper segment flange has a plurality of linear slots and the other of the ground segment flange and the upper segment flange has a plurality of arcuate slots,
said linear and arcuate slots being arranged, shaped and dimensioned such that the flanges are alignable to overlap said linear and arcuate slots to define a plurality of through-bores for receiving fasteners, and such that they define a range of translational motion within which the flanges can be translated relative to one another and a range of rotational motion within which the flanges can be rotated relative to one another, at least one of said plurality of through-bores being maintained throughout said translational and rotational ranges.

10. The system of claim 9, wherein said arcuate slots are segments of a common circle and spaced apart by a common distance.

11. The system of claim 9, wherein said linear slots extend outwardly in a generally radial manner from a central portion of the one of the ground segment flange and the upper segment flange.

12. The system of claim 9, wherein said plurality of linear slots are four in number and extend outwardly in a generally radial manner from a central portion of the one of the ground segment flange and the upper segment flange, and said plurality of arcuate slots are three in number and are segments of a common circle and spaced apart by a common distance.

13. The system of claim 12, wherein said linear slots are disposed in a cruciform relationship.

14. The system of claim 13, wherein said plurality of through-bores is four in number.

15. The system of claim 9, wherein the flanges can be rotationally and/or translationally displaced relative to each other while said through-bores are in receipt of the fasteners.

16. A coupling for aligning an area of attachment of a structure with an area of attachment on a ground or surface, the coupling comprising:
an upper flange attachable to the area of attachment of the structure and a lower flange attachable to the area of attachment on the ground or surface, the upper and lower flanges being releasably securable to one another with planar surfaces thereof disposed in an abutting relation,
a plurality of linear slots defined through one of the upper and lower flanges, and
a plurality of arcuate slots defined through the other of the upper and lower flanges,
said linear and arcuate slots being arranged, shaped and dimensioned such that the flanges are alignable to overlap said linear and arcuate slots to define a plurality of through-bores for receiving fasteners, and such that they define a range of translational motion within which the flanges can be translated relative to one another and a range of rotational motion within which the flanges can be rotated relative to one another, at least one of said plurality of through-bores being maintained throughout said translational and rotational ranges.

17. A solar panel attached to a ground or surface using the coupling of claim 1.

18. A solar panel attached to the ground or surface using the system of claim 9.

19. A solar panel attached to the ground or surface using the coupling of claim 16.
